(19) United States
(12) Patent Application Publication
(10) Pub. No.: US 2026/0071627 A1
(43) Pub. Date: Mar. 12, 2026

(54) Air conditioning assembly and bladeless fan

(71) Applicant: Ningbo Singfun Electric Appliance Co., Ltd., Cixi Ningbo (CN)

(72) Inventors: Yongyuan KUANG, Cixi Ningbo (CN); Yuchu YAO, Cixi Ningbo (CN); Huabing WANG, Cixi Ningbo (CN); Chuanshun CHEN, Cixi Ningbo (CN); Youhong ZHANG, Cixi Ningbo (CN)

(73) Assignee: Ningbo Singfun Electric Appliance Co., Ltd., Cixi Ningbo (CN)

(21) Appl. No.: 19/388,115

(22) Filed: Nov. 13, 2025

(30) Foreign Application Priority Data
Oct. 30, 2025 (CN) 2025223092571

(51) Int. Cl. F04D 25/10; F04D 29/40

(52) U.S. Cl. CPC F04D 25/105; F04D 29/403

(57) ABSTRACT

An air conditioning assembly and a bladeless fan are disclosed. The air conditioning assembly includes an air supply assembly. The air supply assembly includes at least two air supply frames. The at least two air supply frames are mated to form an annular air supply surface. Each air supply frame can be rotated independently.

### TECHNICAL FIELD

The present application relates to an air conditioning assembly and a bladeless fan, and is applicable to a technical field of air conditioning.

### BACKGROUND

The air supply part of an existing bladeless fan typically is designed as an integrated ring structure. The integrated air supply part can only be rotated as a whole and cannot achieve supplying air in multiple swing modes. Moreover, the air supply part is designed as a complete ring structure, which requires the air to be conveyed along the entire ring structure, which makes the air passage transmission distance relatively long and results in higher noise and lower wind speed.

On the other hand, the base and the post of the existing fan are generally connected by a threaded connection, while the conductive pieces inside the base and the post are connected by a plug-in stype. This plug-in electrical connection requires to complete the insertion firstly and then rotation, which makes it prone to sprain damage during rotation due to friction between the contact surfaces or the force applied by the operator, resulting in a poor user experience. Also, the threaded connection does not allow additional sealing components to be placed on the threaded connection surfaces, otherwise the threaded rotation will not be possible, resulting in air leakage on the threaded connection surfaces.

### SUMMARY

The purpose of the present application is to design an air conditioning assembly and a bladeless fan and is intended to address the aforementioned problems existing in the prior art.

The present application relates to an air conditioning assembly, which includes an air supply assembly, the air supply assembly includes at least two air supply frames, the at least two air supply frames are mated to form an annular air supply surface of the air conditioning assembly, and at least one of the air supply frames is rotatably configured.

Wherein, the air conditioning assembly may also include a first connection seat in which an air delivery assembly is provided. The air supply frame is provided with a connector; the connector is connected to the first connection seat so that an air passage within the connector is communicated with an air passage of the air delivery assembly.

The first connection seat may include a fixing seat and a rotating seat. The air delivery assembly comprises an air delivery part and an air passage connection part; the air delivery part is arranged in the rotating seat, the air passage connection part is arranged in the fixing seat. The air passage within the connector is communicated with the air passage of the air delivery part; the air passage of the air passage connection part is communicated with the air passage of the air delivery part.

The connector may be connected to the first connection seat by a first drive mechanism so that each of the air supply frames can be rotated respectively around the axis of the connector on the first connection seat. The first drive mechanism includes a first motor arranged on one of the connector and the rotating seat and a first gear set arranged on the other of the connector and the rotating seat, the first gear set is in a transmission connection with the first motor.

The rotating seat may be connected to the fixing seat by a second drive mechanism so that the rotating seat can be rotated relative to the fixing seat. The second drive mechanism may include a second motor arranged in one of the air delivery part and the fixing seat, and a second gear set arranged in the other of the air delivery part and the fixing seat. The second gear set is in a transmission connection with the second motor.

One end of the connector may be connected to the air delivery part through a bearing, the air passage within the connector is communicated with the air passage within the air supply frame. Each of the air supply frames may be respectively connected to the rotating seat by the connector thereof. The connector of each air supply frame is respectively connected to the rotating seat through the first drive mechanism. An air outlet may be provided on the air supply frame. At least two air supply frames are respectively connected to the first connection seat to mate and form an annular air supply surface.

The air supply assembly may also include an air guide; the air guide is arranged at the connecting position between the air passage of the connector and an air supply passage of the air supply frame to guide air to both sides of an air passage of the air supply frame.

One end of the connector may be provided with an air passage interface, an air passage flared opening is formed within the air passage interface. The air passage interface is connected to the air supply frame. The air guide is arranged in the air passage flared opening so that the air passage flared opening forms an air guide passage, the air guide passage is communicated with the air supply passage. The two sides of the air guide may be respectively formed with an air guide surface, the air guide passage is formed between the air guide surface and the inner wall of the air passage flared opening. The air guide passage comprises a first air guide passage and a second air guide passage. The air passage flared opening is communicated with the air supply passage. The first air guide passage is communicated with one side of the air supply passage, the second air passage is communicated with the other side of the air supply passage. Multiple air outlets may be provided on the air supply frame. The multiple air outlets are respectively communicated with the air supply passage. An guide rib is provided at the respective positions of the air outlets within the air supply passage. The width of the air supply frame may gradually decrease toward both sides of the air supply frame from the connection between the air passage of the connector and the air supply passage.

The present application also relates to a bladeless fan, including an air conditioning assembly as described above.

Wherein, the bladeless fan may also include a base assembly and a post assembly, the base assembly includes a first connection piece and a first conductive piece; the post assembly includes a second mate piece and a second conductive piece. The first connection piece is rotatably connected to the second mate piece, the first conductive piece is electrically connected with the second conductive piece after the first connection piece is connected to the second mate piece by rotation. The first connection piece may be a support frame and the second mate piece may be a second connection seat. The support frame is detachably connected to the second connection seat by a coupling structure. A seal is provided between the first connection piece and the second mate piece. The first conductive piece is arranged on the support frame, the second conductive piece is arranged on the second connection seat. The first conductive piece is an electric contact plate and the second conductive piece is a conductive plate; the conductive plate is pressed onto the second connection seat by a conductive plate press.

By designing the multiple air supply frames to be mated with each other to form an air supply surface and each air supply frame can be rotated independently for air supply, the air conditioning assembly and the bladeless fan presented in the present application can achieve supplying air in various swing modes and at different angles, thereby making the air circulation effect better, significantly increasing the efficiency of air agitation and circulation, and improving the three-dimensional air supply effect and experience of the air conditioning assembly. The air conditioning assembly proposed in the present application is designed with a rotatable connection between the air supply frame and the second connection seat while taking into account the structural communication of the air passages, thereby effectively increasing the air velocity and volume and improving the energy efficiency of the product. It can also improve the sealing between the first and second connection pieces, making it possible to arrange a seal on the connection surfaces, which can improve the sealing effect of the air passages that are mated within the first and second connection pieces. The fan presented in the present application, by using the above connection assembly, can simplify the product structure, reduce costs, facilitate product packaging and transportation, and effectively prevent damage to the electrical connection pieces and enhance the product experience.

### BRIEF DESCRIPTION OF THE DRAWINGS

FIG. 1 is a first schematic diagram of an air conditioning assembly of the present application.

FIG. 2 is a second schematic diagram of an air conditioning assembly of the present application.

FIG. 3 is a partial explosion diagram of the first embodiment of an air conditioning assembly of the present application.

FIG. 4 is a schematic diagram of the air supply frame and its transmission structure of the present application.

FIG. 5 is a first partial sectional view of the air conditioning assembly of the present application.

FIG. 6 is a second partial sectional view of the air conditioning assembly of the present application.

FIG. 7 is a third partial sectional view of the air conditioning assembly of the present application.

FIG. 8 is a sectional view of an air conditioning assembly of the present application.

FIG. 9 is a first schematic diagram of the rotation of the air supply assembly of the air conditioning assembly of the present application.

FIG. 10 is a second schematic diagram of the rotation of the air supply assembly of an air conditioning assembly of the present application.

FIG. 11 is a partial explosion diagram of a second embodiment of an air conditioning assembly of the present application.

FIG. 12 is a forth partial sectional view of the air conditioning assembly of the present application.

FIG. 13 is a fifth partial sectional view of the air conditioning assembly of the present application.

FIG. 14 is a sixth partial sectional view of the air conditioning assembly of the present application.

FIG. 15 is a schematic diagram of the connector structure of the present application.

FIG. 16 is a sectional view of the connection assembly of the present application.

FIG. 17 is a partial explosion view of the post assembly of the present application.

FIG. 18 is a schematic diagram of the support frame structure of the present application.

FIG. 19 is an explosion diagram of the air supply assembly of the present application.

### DETAILED DESCRIPTION

To make the purpose, technical solution and advantages of the present application clearer, the embodiments of the present application will be described in detail with the drawings. It should be noted that, in the absence of conflict, the embodiments of the present application and the features of the embodiments may be combined arbitrarily with each other. The air conditioning assembly of the present application may be used in various possible scenarios such as fans, blowing devices, heaters, etc.

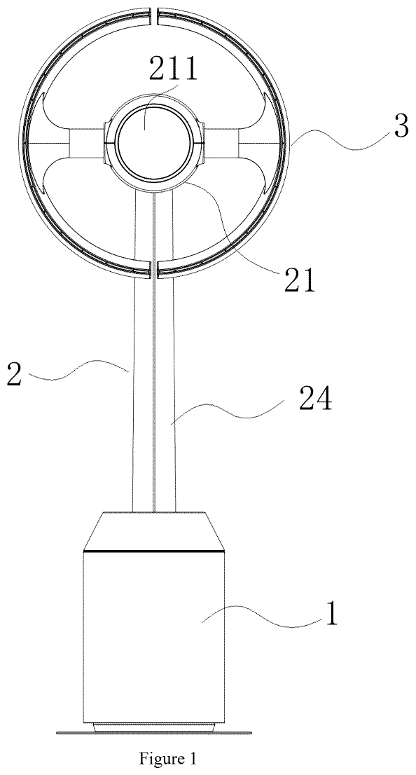

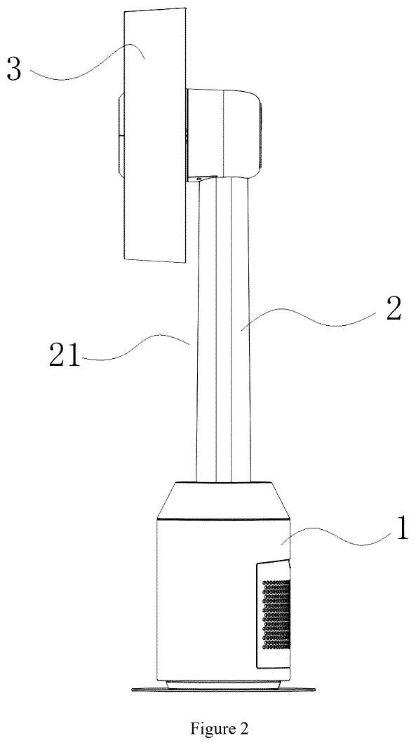

As shown in FIGS. 1-2, and 10, the present application presents an air conditioning assembly, which in the embodiments is shown as a bladeless fan. It is known to those skilled in the art that the air supply assembly therein can also be used in various possible scenarios, such as the aforementioned fan, blowing device, heater, etc. As shown in the figure, the air conditioning assembly of the present application comprises an air supply assembly 3, which is set on the post assembly 2. The post assembly 2 is set on the base assembly 1, the air supply assembly 3 is set on the post assembly 2. Alternatively, the air supply assembly 3 can also be directly installed on the base assembly 1 without the need for the post assembly 2. A blower may be installed in the base assembly 1 to create airflow through the blower into the air passage of the post assembly 2. The air passage of the post assembly 2 is communicated to an air passage of the air supply assembly 3, so that air can be delivered to the air passage of the air supply assembly 3 and blown out from an air outlet of the air supply assembly 3. The air supply assembly 3 includes at least two air supply frames 31, each of which is preferably arc-shaped. The at least two air supply frames 31 are respectively connected to the post assembly 2 to mate and form an annular air supply surface of the air conditioning assembly. Each air supply frame 31 can be rotated independently on the post assembly 2, thereby achieving an air supply in multiple rotatable modes. Taking the above scheme, by designing the air supply assembly with multiple air supply frames, and designing each air supply frame to be separately connected to the post assembly and to be rotated independently, it is possible to achieve the air supply of the air conditioning assembly in multiple swing modes. The air conditioning assembly presented in the present application can achieve a three-dimensional air supply effect, significantly improving the air circulation efficiency, making the air circulation effect better, and achieve an air supply in different angles. It can be understood by those skilled in the art that the annular air supply surface in the present application means that the annular air supply surface is structurally discontinuous but forms a ring-shaped air supply surface, which can be a circular ring, a rectangle ring or any other possible annular shape.

As shown in FIGS. 1-3, 5, and 7, in some embodiments, the post assembly 2 comprises a first connection seat 21 and a post 24. The first connection seat 21 is set on the post 24, the air passage of the first connection seat 21 is communicated with the air passage of the post 24. An air deliver assembly is equipped in the first connection seat 21, the air supply frame 31 is provided with a connector 32. Specifically, the connector 32 is rotatably connected to the first connection seat 21 so that the connector 32 can rotate relative to the first connection seat 21 around the axis of the connector 32. The air passages within the connector 32 are also communicated with the air passages of the air delivery assembly within the first connection seat 21 for the purpose of guiding the air. With the above scheme, the air supply frame is connected to the post through the connection seat and the air passages are communicated, thus enabling to guide and supply air, ensuring the efficiency and velocity of the air supplying in the bladeless air conditioning assembly.

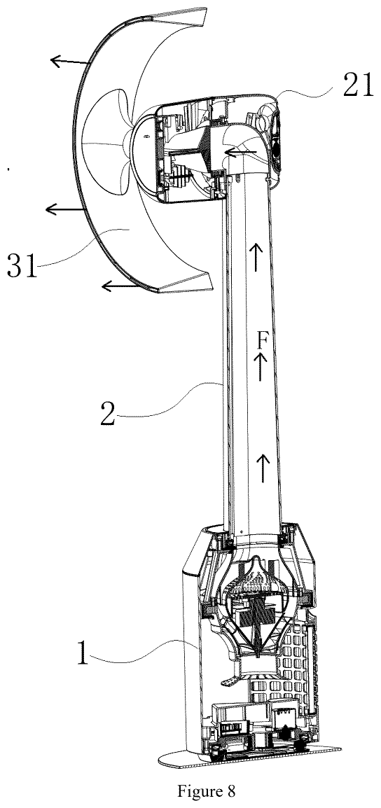

As shown in FIGS. 1-3, 5, and 7, in some embodiments, the first connection seat 21 comprises a fixing seat 22 and a rotating seat 23, herein the fixing seat 22 is connected to the post assembly 2 and the air passages are communicated. The rotating seat 23 is set on the fixing seat 22 and is able to rotate relatively on the fixing seat 22, thereby driving the entire air supply assembly to rotate. Specifically, the air deliver assembly in the first connection seat 21 includes an air delivery part and an air passage connection part 216; herein, the air delivery part is set in the rotating seat 23 and is connected to the air passage connection part 216, thereby achieving the communication of the air passage. The connector 32 is rotatably connected to the air delivery part so as to rotate around a rotational axis thereof. The air passage connection part 216 is set within the fixing seat 22 and is communicated with the air passage of the post 24. Using the above scheme, it is possible to design that the air passage in the connector 32 is communicated with the air passage of the air delivery part, the air passage of the air passage connection part 216 is respectively communicated with the air passage of the air delivery part and the air passage of the post assembly 2, so that the airflow formed by the blower in the base assembly 1 can be successively transmitted through the air passage of the post 24, the air passage connection part 216, the air delivery part to the air supply assembly, to achieve an efficient transmission. The specific direction of air flowing refers to “F”in FIG. 8.

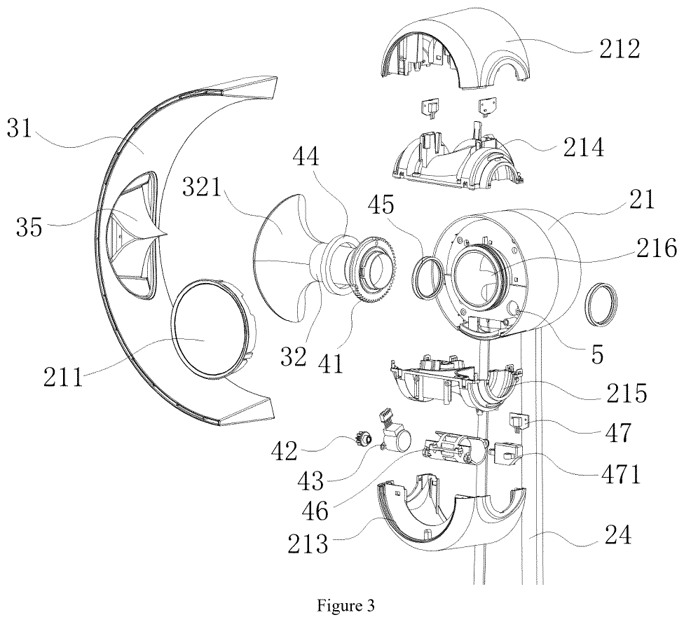

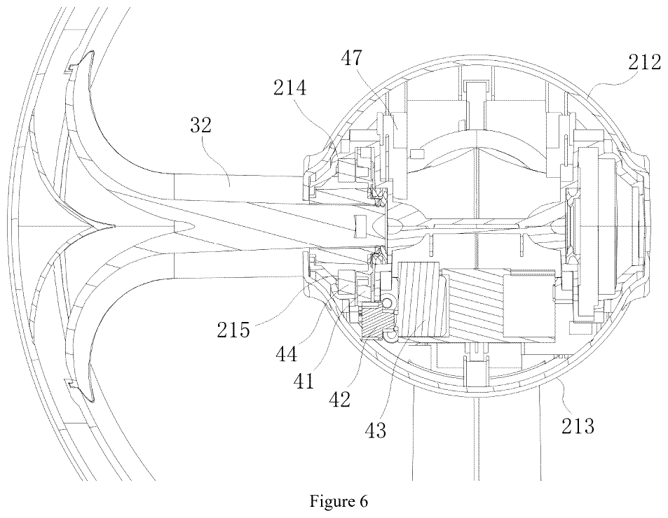

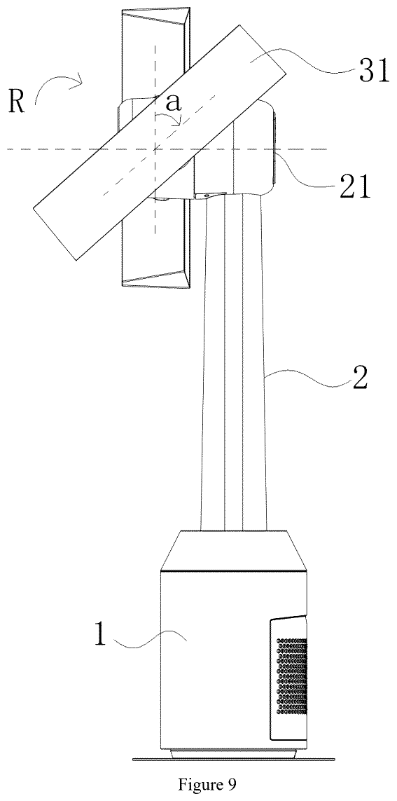

As shown in FIGS. 3-7, in some embodiments, the connector 32 is connected to the first connection seat 21 through a first drive mechanism, so that each air supply frame 31 can be rotated around the rotating axis of the connector on the first connection seat 21 respectively. The air supply frame 31 rotates around the rotating axis of the connector on the first connection seat 21, as shown in FIG. 9, at an angle a of 0° to 110°, preferably 40° to 60°. Specifically, the first drive mechanism comprises a first motor 43 and a first gear set; herein, the first gear set is set on the connector 32, the first motor 43 is set on the rotating seat 23, or, the first gear set is set on the rotating seat 23 and the first motor 43 is set on the connector 32. Further, the first gear set is in transmission connection with the first motor 43, to drive the first gear set through the first motor 43, so as to make the air supply frame 31 rotate around the rotation axis of the connector 32. Specifically, the first gear set includes a first driven gear 41 and a first driving gear 42. The first driven gear 41 is connected to the connector 32, the first driving gear 42 is connected to the output shaft of the first motor 43. The first driven gear 41 and the first driving gear 42 mesh with each other to achieve a transmission fit. In the rotating seat 23 are provided with a motor bracket 46, an induction switch 47 and a switch bracket 471. The first motor 43 is fixedly set on the motor bracket 46. The induction switch 47 is set on the switch bracket 471, thereby achieving an operation induction. Magnets 5 are respectively provided on the connector 32 and the fixing seat 22, so that when the connector 32 is rotated to a preset angle on the rotating seat 23, the magnet 5 on the connector 32 can induct mutually with the magnet 5 on the fixing seat 22, thereby enabling the start and stop through electrical control.

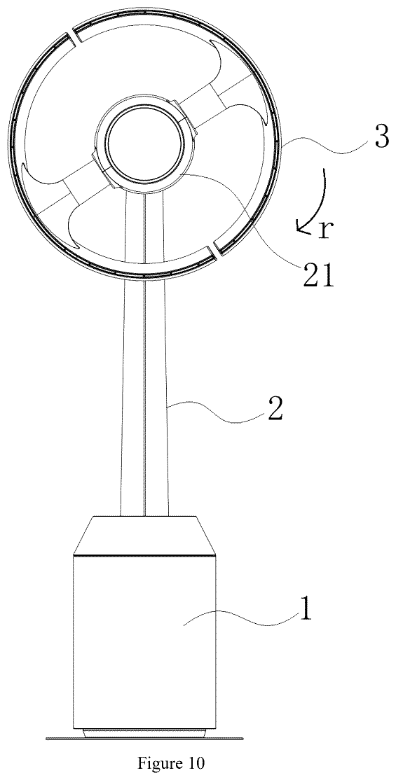

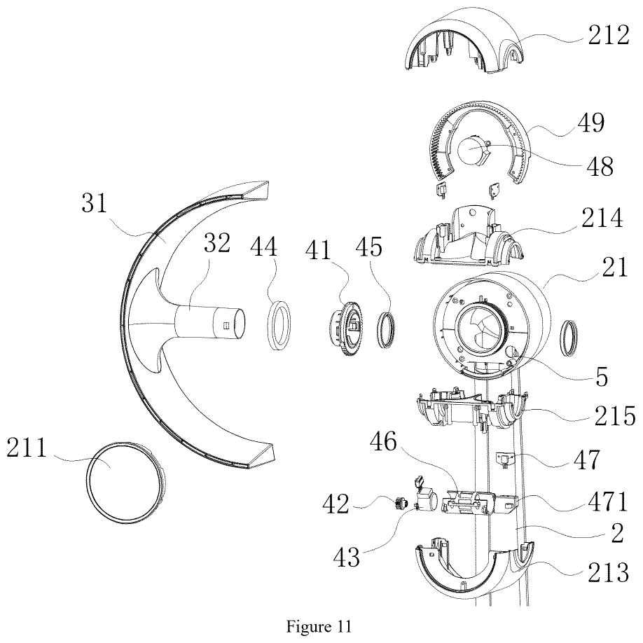

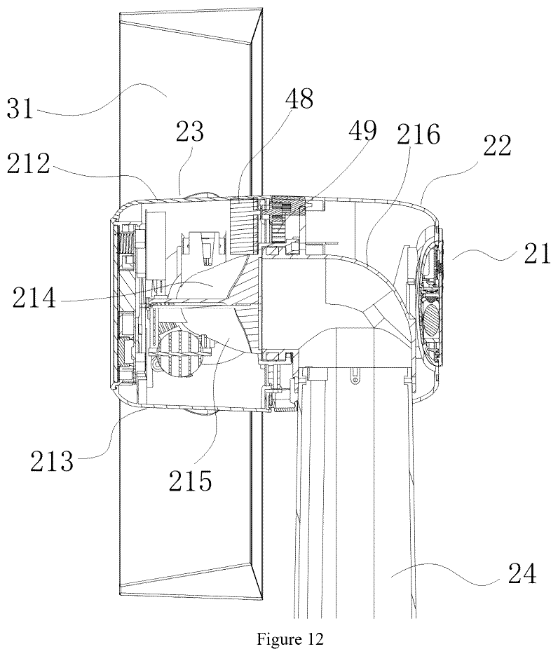

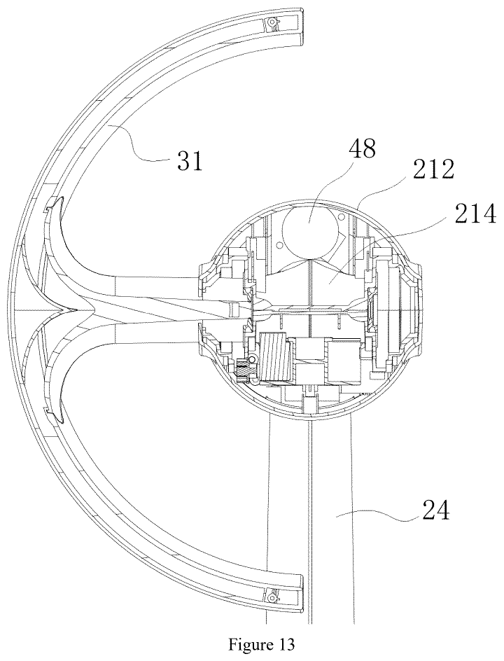

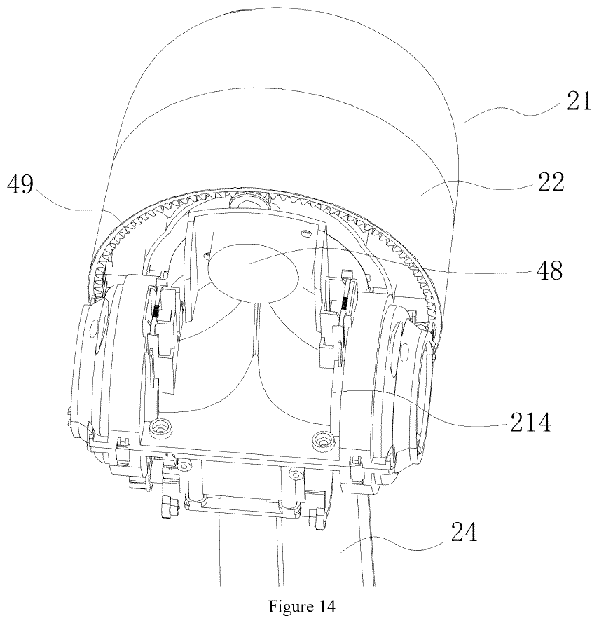

As shown in FIGS. 11-14, in some embodiments, the rotating seat 23 and the fixing seat 22 are connected by a second drive mechanism, so that the rotating seat 23 can be rotated relative to the fixing seat 22, thereby driving the entire air supply assembly to rotate around the axis of the first connection seat 21. The air supply assembly 3 is rotated around the axis of the first connection seat 21, as shown in FIG. 10. The rotation angle is from 0° to 180°, which makes full use of the various air outlets on the air supply frame 31 for air blowing and achieves annular air supply. Specifically, the second drive mechanism includes a second motor 48 and a second gear set; herein, the second motor 48 is set on the air deliver part, the second gear set is set in the fixing seat 22; or, the second gear set is set on the air delivery part and the second motor 48 is set in the fixing seat 22. The second gear set is in a transmission connection with the second motor 48, to drive the second gear set through the second motor 48, so as to rotate the rotating seat 23 on the fixing seat 22. Specifically, the air delivery part includes an air delivery part upper cover 214 and an air delivery part lower cover 215, which are combined to form the air delivery part. The rotating seat 23 includes the rotating seat upper cover 212 and the rotating seat lower cover 213, which are combined to form the rotating seat 23. Further, the air delivery part upper cover 214 is provided with a motor support frame, the second motor 48 is fixedly set on the motor support frame. Further, the second gear set includes a second driven gear 49 and a second driving gear, the second driven gear 49 can be an internal gear, the second driven gear 49 is set in the fixing seat 22, the second driven gear 49 and the second driving gear mesh with each other, the second driving gear is connected to the output shaft of the second motor 48 to achieve a transmission fit.

As shown in FIGS. 3, 5, and 11, in some embodiments, the air delivery part is fixedly set in the rotating seat 23. The air delivery part includes an air delivery part upper cover 214 and an air delivery part lower cover 215 which are interconnected with each other. One end of the connector 32 is connected to the air delivery part through a bearing 44, which can enhance the support stability of the connector. A silicone ring 45 is provided between the connector 32 and the air delivery part. The silicone ring 45 can act as a seal between the connector 32 and the air delivery part to prevent air leakage in the air passages of the connector 32 and the air delivery part, thereby increasing the air supplying velocity and efficiency. The air passage within the connector 32 is also communicated with the air passage within the air supply frame 31 for air supply.

As shown in FIGS. 1, 7, 9, and 10, in some embodiments, the number of air supply frame 31 is preferably two, and each air supply frame 31 is respectively connected to the rotating seat 23 of the first connection seat 21 through its connector 32. The connector 32 of each air supply frame 31 is respectively connected to the rotating seat 23 through the first drive mechanism to enable independent rotation. That is, each air supply frame 31 can be independently rotated around the axis of its connector 32 on the rotating seat 23 to achieve the air supply in multiple swing modes.

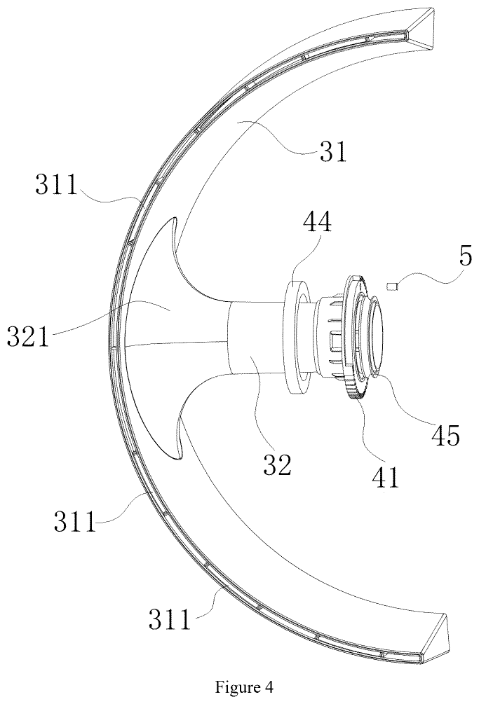

As shown in FIGS. 4, 5, and 10, in some embodiments, multiple air outlets 311 are arranged at intervals on the air supply frame 31, each air outlet 311 is independently communicated with the air passage within the air supply frame 31. The air supply frame 31 can be a circular arc structure, a rectangle structure, an elliptical arc structure, etc. At least two air supply frames 31 are respectively connected to the post assembly 2 and mated to form an annular air supply surface. The “annular” of the present application is not limited to circular annular, but also includes various forms of annular air supply surfaces, and may even be rectangle, polygonal, elliptical or various irregular shapes. Specifically, at least two air supply frames 31 are respectively connected to the rotating seat 23 of the first connection seat 21 to form an annular air supply frame. The annular air supply frame can be rotated as a whole around the horizontal axis to achieve a rotating air supply, as shown by “r” in FIG. 10.

As shown in FIGS. 3 and 4, in some embodiments, the air supply assembly 3 also includes an air guiding component 35. The air guiding component 35 is set at the connecting position between the air passage of the connector 32 and the air passage of the air supply frame 31, so as to guide the air to both sides of the air passage within the air supply frame 31. With the above scheme, by setting the air guiding component 35 at the connecting position between the air passage of the connector 32 and the air passage of the air supply frame 31, the air in the air passage of the connector 32 can be directed through the air guiding component 35, thereby quickly and evenly entering both sides of the air passage of the air supply frame 31, improving the air supply efficiency and making the air supply of the air supply frame 31 more balanced. Preferably, the cross-sections of the air supply frame 31 and its air passage are gradually narrowing sections, the air outlets 311 are located at the narrowest part of the air passage of the air supply frame 31, which are beneficial to increase the air supplying velocity.

As shown in FIGS. 3, 4, and 7, in some embodiments, one end of the connector 32 is provided with an air passage interface 321. An air passage flared opening is formed within the air passage interface 321. The air passage interface 321 is connected to the air supply frame 31, specifically connected to the middle position of the air supply frame 31, the connection way of which can be either separately formed or integrally formed. The air guiding component 35 is set in the air passage flared opening to make the air passage flared opening form an air guide passage. The air guide passage is communicated with the air passage of the air supply frame 31 to achieve air guiding. With the above scheme, the air passage flared opening can expand the air supply space, facilitate the installation and air diversion of the air guiding component 35, and also expand the connection surface between the air passage interface 321 and the air supply frame 31, thereby making the structure more stable.

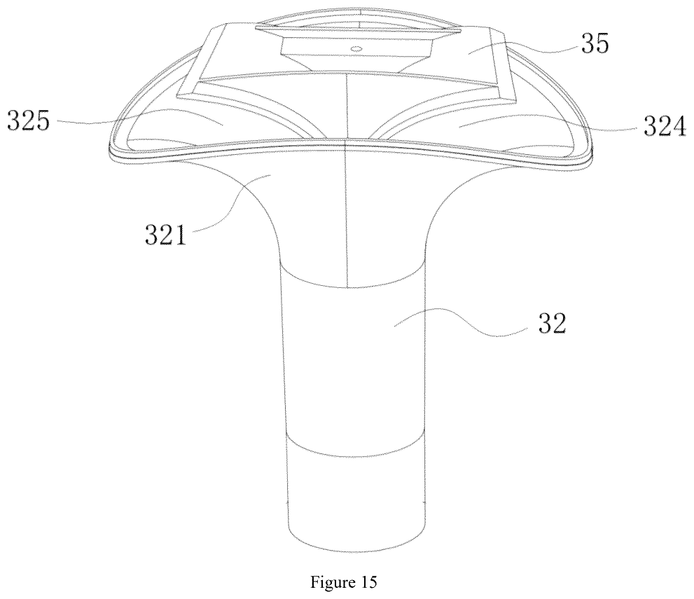

As shown in FIGS. 4 and 15, in some embodiments, the cross-section of the air guiding component 35 is a V-shaped structure. The two sides of the air guiding component 35 are symmetrical and respectively form arc-shaped air guide surfaces. An air guide passage is formed between the arc-shaped air guide surface and the inner wall of the air passage flared opening, and communicated with the air passage of the air supply frame 31. Preferably, the air passage flared opening is communicated with the air passage of the air supply frame 31, specifically with the middle position of the air passage of the air supply frame 31 for connecting the air passages. Specifically, the air guide passages include a first air guide passage 324 and a second air guide passage 325. The first air guide passage 324 is communicated with one side of the air passage of the air supply frame 31, the second air guide passage 325 is communicated with the other side of the air passage of the air supply frame 31, so that air can be directed along both sides of the air passage of the air supply frame 31, which makes the air supply more balanced.

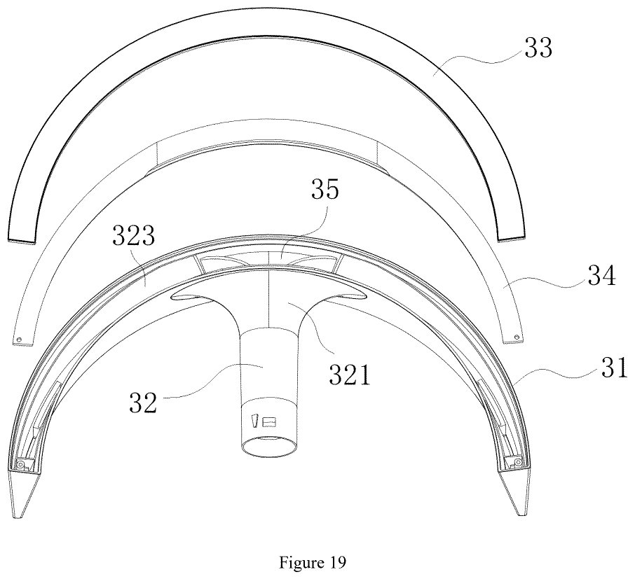

As shown in FIGS. 4 and 19, in some embodiments, multiple air outlets 311 are provided on the air supply frame 31, the air outlet 311 can be long strip shaped. Preferably, multiple air outlets 311 are evenly distributed along the length direction of the air supply frame 31 and are located on the end surface of the air supply frame 31. An air supply passage 323 is set in the air supply frame 31, multiple air outlets 311 are respectively communicated with the air supply passage 323. Specifically, there is an air guide rib at each air outlet 311 within the air supply passage 323, so that by setting the air guide rib to different lengths or shapes, the air volume of the outlet can be adjusted according to the distance from the outlet to the passage interface, the air within the air supply passage 323 can be evenly discharged through the air outlet 311. The problem of air accumulation within the air passage of the air supply frame 31 can be solved.

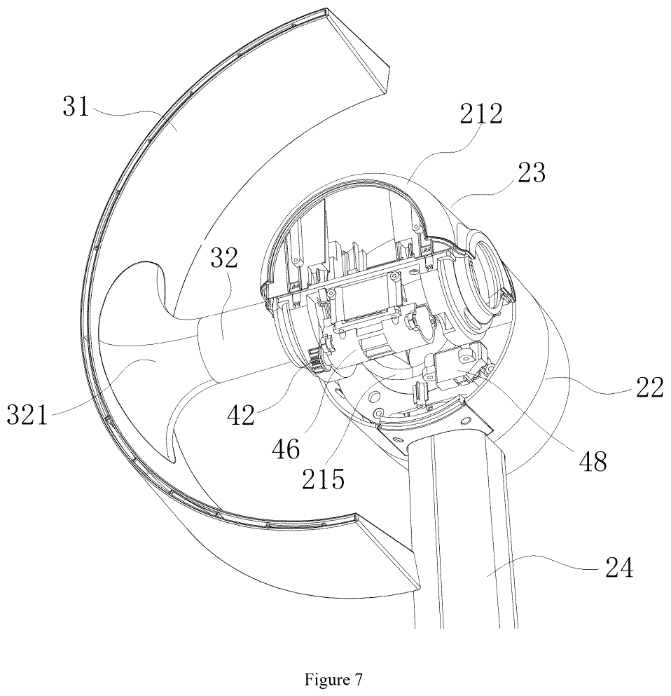

As shown in FIGS. 4 and 7, in some embodiments, the air supply frame 31 is an arc-shaped structure, preferably a semi-circular arc structure. The air supply frame 31 is designed as an arc-shaped structure, the air supply passages within the air supply frame 31 are also arc-shaped passages. The width of the arc-shaped passages gradually decreases toward both sides of the air supply frame 31 from the connection between the connector and the air supply frame 31, so that the air within the air supply frame 31 can be stably and evenly blown out from each air outlet 311 according to the characteristic that the air volume to be blown out through the air outlets in sequence will decrease gradually. The air supply assembly presented in the present application can shorten the air supply passage by setting the air supply frame as an arc-shaped structure, so that the air entering the air supply passage can be quickly discharged, thereby increasing the air velocity, reducing noise, and avoiding the problem of air accumulation caused by the excessive length of the air supply passage.

As shown in FIG. 19, in some embodiments, the air supply assembly 3 also includes an air supply frame cover plate 33 and an air guide cover plate 34. The air supply frame cover plate 33 and the air guide cover plate 34 can be formed as a whole, or formed separately and assembled together. Herein, the air guide cover plate 34 is set in the air passage of the air supply frame 31 and forms a sealed air passage with the air passage of the air supply frame 31, thereby improving the air guide efficiency and the air supply efficiency. The air passage within the air supply frame 31 is the air supply passage 323. The air supply frame cover plate is set on the outside of the air guide cover plate and covers the air guide cover plate, providing for overall sealing, protection and decoration.

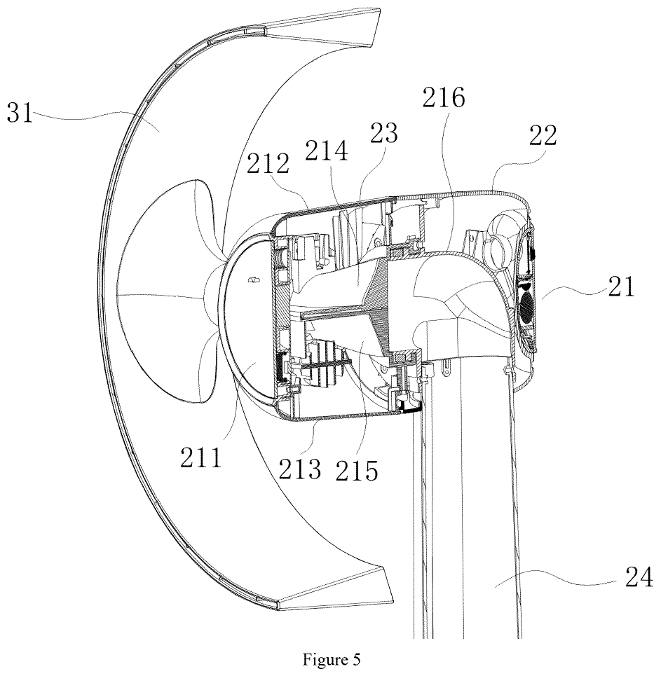

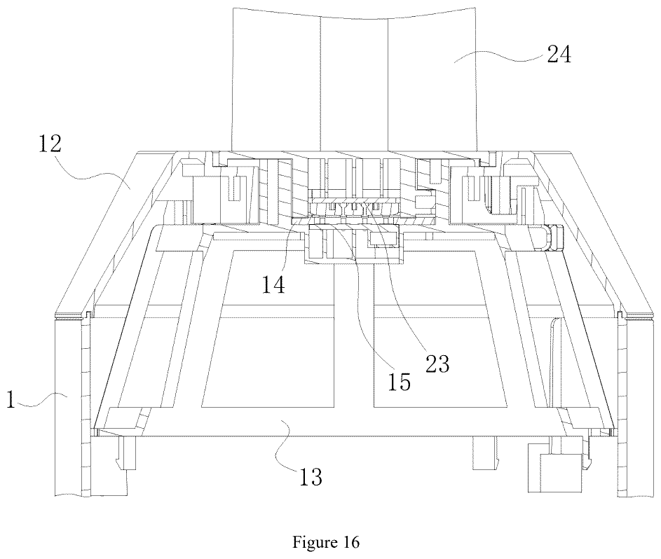

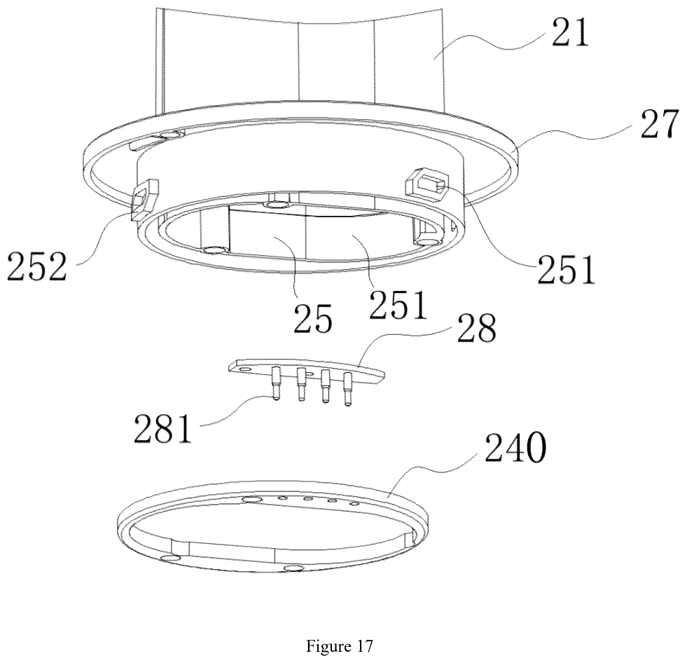

As shown in FIGS. 1 and 5, in some embodiments, the air delivery assembly is provided within the first connection seat 21, the other end of the connector 32 is connected to the first connection seat 21, so that the air passage of the connector 32 is communicated with the air passage within the air delivery assembly. As shown in FIGS. 16 and 17, in some embodiments, the base assembly 1 includes a first connection piece and a first conductive piece, with the first conductive piece arranged on the first connection piece. The post assembly 2 includes a second mate piece and a second conductive piece, with the second conductive piece arranged on the second mate piece. Specifically, the first connection piece is detachably coupled together with the second mate piece by rotation, so that the first conductive piece and the second conductive piece are electrically connected. The connection assembly presented in the present application is designed with the first connection piece and the second mat e piece directly rotatably connected, which is convenient to disassemble and assemble and convenient to package and transport, which has a relatively simple and practical structure and can simply achieve an electrical connection.

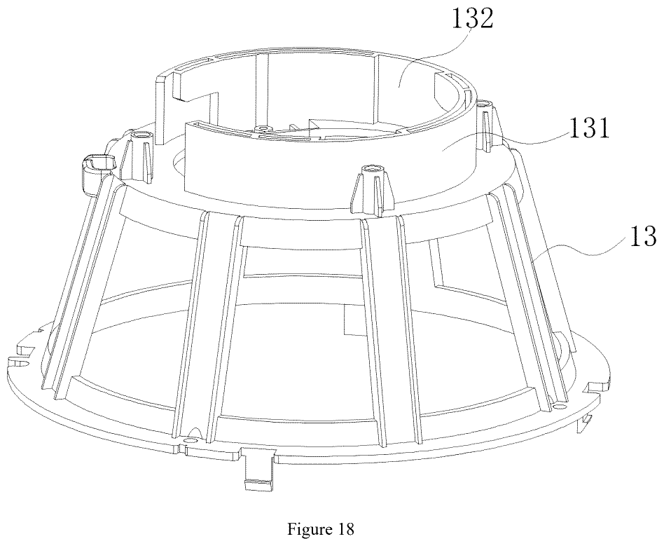

As shown in FIGS. 16, 17, and 18, in some embodiments, the first connection piece is a support frame 13 and a first air passage is provided in the first connection piece. The second mate piece is a second connection seat 25, and a second air passage 251 is provided in the second mate piece. Specifically, the support frame 13 and the second connection seat 25 are joined together by rotation, the first air passage 18 is thus communicated with the second air passage 251, realizing the purpose of guiding the air. Further, the post assembly 2 also includes a post 24, the air passage within the post 24 is communicated with the second air passage 251 of the second connection seat 25. The connection assembly presented in the present application can achieve an alternated seal through connecting the first connection piece and the second mate piece by rotation, thereby avoiding the air leakage in the air passage structure between the first connection piece and the second mate piece.

As shown in FIGS. 16, 17, and 18, in some embodiments, the first connection piece is a support frame 13, which is provided with a support wall 131, the first air passage is arranged vertically at the center of the support frame 13 and on the inner side of the support wall 131. The second mate piece is the second connection seat 25, the second air passage is arranged vertically at the center of the second connection seat 25. The support wall 131 and the second connection seat 25 are detachably coupled together by a coupling structure. Specifically, the coupling structure includes a coupling slot and a protrusion 252, with the protrusion 252 interlocking with the coupling slot by rotation. Preferably, the coupling slot is set on the side wall of the support wall 131, the protrusion 252 is set on the side wall of the second connection seat 25. The protrusion 252 can be inserted vertically into the coupling slot and engaged with the coupling slot by rotating horizontally and clockwise, thus achieving a sealed connection. Preferably, at least three protrusions 252 may be designed to improve the stability and sealing of the coupling. With the above scheme, the support frame 13 and the second connection seat 25 are coupled together by rotation to achieve a sealed connection and prevent air leakage in the air passages.

As shown in FIGS. 16, 17, and 18, in some embodiments, the first conductive piece is set on the support frame 13 and the second conductive piece is set on the second connection seat 25. Specifically, the first conductive piece is an electric contact plate 15, which can be a copper plate structure. The electric contact plate 15 is set on the support frame 13 and may be set on the end surface inside of the support wall 131. The second conductive piece is a conductive plate 28, which is set on the second connection seat 25 and may be set on the bottom surface of the second connection seat 25. Specifically, the electric contact plate 15 is provided with an electric contact slot and the conductive plate 28 is provided with retractable copper pin 281. With the above scheme, when the second connection seat 25 is coupled together with the support frame 13 by rotation, the copper pin 281 can achieve an electrical connection by rotating to the position of the electric contact slot and making contact with the electric contact slot.

As shown in FIGS. 16, 17, and 18, in some embodiments, the post assembly 2 further includes a conductive plate press 240, which is pressed onto the second connection seat 25, the conductive plate 28 is thus clamped between the conductive plate press and the second connection seat 25. Preferably, the conductive plate press is an annular structure with through holes provided thereon, through which the copper pin 281 can pass. Using the above scheme, the conductive plate 28 is pressed onto the second connection seat 25 by providing the conductive plate press, which makes the connection and fixation of the conductive plate 28 more reliable, and also enhances the strength of the second connection seat 25 to prevent damage caused by an excessive rotation of the second connection seat 25.

As shown in FIGS. 16, 17, and 18, in some embodiments, the base assembly 1 may further include a sealing ring 14, which can be a silicone ring. The sealing ring 14 is provided on the support frame 13, with the electric contact plate 15 sandwiched between the sealing ring 14 and the support frame 13, so that the support frame 13 and the second connection seat 25 can be fit tightly when being coupled together, avoiding the air leakage in the air passage between the support frame 13 and the second connection seat 25. Specifically, the electric contact plate 15 may be clamped between the sealing ring 14 and the end surface of the support frame 13. The sealing ring 14 is provided with an open slot, which fits with the electric contact plate 15, allowing the copper pin 281 on the conductive plate 28 to pass through the open slot and come into contact with the electric contact plate 15.

As shown in FIGS. 16, 17, and 18, in some embodiments, in order to prevent accidental disassembly between the support frame 13 and the second connection seat 25, the support frame 13 and the second connection seat 25 may be also detachably connected by a limit element, which serves to prevent a maloperation. An unlock and lock marks may be provided on the post base 27. Specifically, the limit element includes an elastic limit pin and an unlocking hole that are compatible with each other. Preferably, the unlocking hole is provided on the post base 27 and is opposite to the limit pin. The limit pin is set on the support frame 13 via a spring, to achieve a function of expansion and contraction. With the above scheme, when the support frame 13 and the second connection seat 25 are rotated to a preset angle and coupled, the limit pin and the unlocking hole can be coupled together to achieve locking. When it is needed to unlock, the limit pin is pushed off the unlocking hole by compressing the limit pin along the unlocking hole through an insert, and then rotating the second connection seat 25 to achieve unlocking.

By designing the air supply assembly to include multiple air supply frames, and designing each air supply frame that could be rotated independently for air supply, the air conditioning assembly presented in the present application can achieve supplying air in multiple swinging modes and at different angles, so that the air circulation effect is better, the efficiency of air agitation and circulation is significantly enhanced, the three-dimensional air supply effect and the experience of the air conditioning assembly is improved. Compared with a single-strip shaped air supply assembly, the annular air supply assembly can have a more uniform and softer air blowing effect.

By designing the air supply frame to be rotatable with respect to the connection seat and while making the air passage structures communicated, the air conditioning assembly presented in the present application can effectively increase the air velocity and volume and improve the energy efficiency of the product.

By designing the first and second connection pieces to firstly rotate and then achieve electric connection, the present application can facilitate disassembly and assembly, and facilitate packaging and transportation. It can avoid the existing problem of frictional or torsional damage between the inserts due to rotation. It can also improve the sealing between the first connection piece and the second connection piece, thereby making it possible to set a seal on the connection surfaces, and achieving a better sealing of the air passages within the first connection piece and the second connection piece. The fan presented in the present application, by using the above connection assembly, can simplify the product structure, reduce costs, facilitate product packaging and transportation, and can effectively avoid damage to the electrical connection pieces and improve the product experience.

Although the embodiments disclosed in the present application are as described above, the contents are only embodiments adopted for the purpose of understanding the present application and are not intended to limit the present application. Any person skilled in the art to which the application pertains may, without departing from the spirit and scope disclosed in the application, make any modifications and changes to the form and details of the application, but the scope of the patent protection of the application shall be subject to the scope defined in the appended claims.

1. An air conditioning assembly, comprising an air supply assembly, wherein, the air supply assembly comprises at least two air supply frames, the at least two air supply frames are mated to form an annular air supply surface of the air conditioning assembly, at least one of the air supply frames is rotatably configured.

2. The air conditioning assembly according to claim 1, wherein, the air supply assembly further comprises a first connection seat, in which an air delivery assembly is provided; the air supply frame is provided with a connector; the connector is connected to the first connection seat, so that an air passage within the connector is communicated with an air passage of the air delivery assembly.

3. The air conditioning assembly according to claim 2, wherein, the first connection seat comprises a fixing seat and a rotating seat, the air delivery assembly comprises an air delivery part and an air passage connection part; the air delivery part is arranged in the rotating seat, the air passage connection part is arranged in the fixing seat; the air passage within the connector is communicated with an air passage of the air delivery part; an air passage of the air passage connection part is communicated with the air passage of the air delivery part.

4. The air conditioning assembly according to claim 3, wherein, the connector is connected to the first connection seat by a first drive mechanism, so that each of the air supply frames can be rotated respectively around the axis of the connector on the first connection seat.

5. The air conditioning assembly according to claim 4, wherein, the first drive mechanism comprises a first motor arranged on one of the connector and the rotating seat and a first gear set arranged on the other of the connector and the rotating seat, the first gear set is in a transmission connection with the first motor.

6. The air conditioning assembly according to claim 3, wherein, the rotating seat is connected to the fixing seat by a second drive mechanism, so that the rotating seat can be rotated relative to the fixing seat.

7. The air conditioning assembly according to claim 6, wherein, the second drive mechanism comprises a second motor arranged in one of the air delivery part and the fixing seat and a second gear set arranged in the other of the air delivery part and the fixing seat, the second gear set is in a transmission connection with the second motor.

8. The air conditioning assembly according to claim 3, wherein, one end of the connector is connected to the air delivery part through a bearing, the air passage in the connector is communicated with an air passage in the air supply frame.

9. The air conditioning assembly according to claim 4, wherein, each of the air supply frames is respectively connected to the rotating seat through the connector thereof; the connector of each air supply frame is respectively connected to the rotating seat through the first drive mechanism.

10. The air conditioning assembly according to claim 2, wherein, an air outlet is provided on the air supply frame, at least two air supply frames are respectively connected to the first connection seat to mate and form the annular air supply surface.

11. The air conditioning assembly according to claim 2, wherein, the air supply assembly further comprises an air guide, which is arranged at the connecting position between the air passage of the connector and an air supply passage of the air supply frame to guide the air to both sides of the air passage of the air supply frame.

12. The air conditioning assembly according to claim 11, wherein, one end of the connector is provided with an air passage interface, within which an air passage flared opening is formed, the air passage interface is connected to the air supply frame; the air guide is arranged in the air passage flared opening so that the air passage flared opening forms an air guide passage, the air guide passage is communicated with the air supply passage.

13. The air conditioning assembly according to claim 12, wherein, both sides of the air guide are respectively formed with an air guide surface, the air guide passage is formed between the air guide surface and an inner wall of the air passage flared opening, the air guide passage comprises a first air guide passage and a second air guide passage; the air passage flared opening is communicated with the air supply passage; the first air guide passage is communicated with one side of the air supply passage, the second air guide passage is communicated with the other side of the air supply passage.

14. The air conditioning assembly according to claim 11, wherein, multiple air outlets are provided on the air supply frame; the multiple air outlets are respectively communicated with the air supply passage; an air guide rib is respectively provided at the positions of the air outlets within the air supply passage.

15. The air conditioning assembly according to claim 11, wherein, the width of the air supply frame gradually decreases toward both sides of the air supply frame from the connection between the air passage of the connector and the air supply passage.

16. A bladeless fan, wherein the bladeless fan comprises an air conditioning assembly according to claim 1.

17. The bladeless fan according to claim 16, wherein, the bladeless fan further comprises a base assembly and a post assembly, the base assembly comprises a first connection piece and a first conductive piece; the post assembly comprises a second mate piece and a second conductive piece;
the first connection piece is rotatably connected to the second mate piece, the first conductive piece is electrically connected with the second conductive piece after the first connection piece is connected to the second mate piece by rotation.

18. The bladeless fan according to claim 17, wherein, the first connection piece is a support frame and the second mate piece is a second connection seat; the support frame is detachably connected to the second connection seat by a coupling structure.

19. The bladeless fan according to claim 17, wherein, a seal is provided between the first connection piece and the second mate piece.

20. The bladeless fan according to claim 18, wherein, the first conductive piece is arranged on the support frame and the second conductive piece is arranged on the second connection seat; the first conductive piece is an electric contact plate, the second conductive piece is a conductive plate; the conductive plate is pressed onto the second connection seat by a conductive plate press.
